(19) United States
(12) Patent Application Publication
(10) Pub. No.: US 2025/0094865 A1
(43) Pub. Date: Mar. 20, 2025

(54) ENSURING THAT LANGUAGE MODELS FOLLOW INSTRUCTIONS INDICATED IN PROMPTS

(71) Applicant: Oracle International Corporation, Redwood Shores, CA (US)

(72) Inventors: Zheng Wang, Sammamish, WA (US); Yazhe Hu, Bellevue, WA (US); Mengqing Guo, Redmond, WA (US); Tao Sheng, Bellevue, WA (US); Jun Qian, Bellevue, WA (US); Vinod M. Mamtani, Bellevue, WA (US)

(21) Appl. No.: 18/629,917

(22) Filed: Apr. 8, 2024

Related U.S. Application Data
(60) Provisional application No. 63/538,736, filed on Sep. 15, 2023.

(51) Int. Cl. G06N 20/00; G06F 40/40

(52) U.S. Cl. CPC G06N 20/00; G06F 40/40

(57) ABSTRACT

Techniques for ensuring that language models follow instructions indicated in prompts are provided. In one technique, a first language model generates a response based on a prompt. A set of instructions in the prompt is identified. For each instruction in the set, a second language model determines whether the response indicates that the first language model followed the instruction. In another technique, for each prompt of a plurality of prompts: (1) a first language model generates a response based on the prompt; (2) multiple instructions are identified based on the prompt; (3) a second language model generates, based on the plurality of instructions, an output that indicates that the first language model followed each instruction; and (4) the prompt, the response, and the multiple instructions are stored in a training instance. The first language model is finetuned based on the training instances.

### BENEFIT CLAIM

This application claims the benefit of U.S. Provisional Application No. 63/538,736, filed Sep. 15, 2023, the entire contents of which is hereby incorporated by reference as if fully set forth herein, under 35 U.S.C. § 119(e).

### TECHNICAL FIELD

The present disclosure relates to language models and, more particularly, to modifying prompts to improve the following ability of language models.

### BACKGROUND

Language models (LMs), including large language models (LLMs), do not follow human intents well from pre-training. LM responses can be better aligned with human intents through instruction tuning and reinforcement learning with human or model feedback (RLHF/RLAIF). Instruction tuning fine-tunes a model to predict a certain response given a prompt, where the prompt may optionally include an instruction that explains a task to the model. Instruction tuning has been shown to improve the zero-shot generalization of LMs to unseen tasks. RLHF/RLAIF further aligns models with human intent on top of instruction tuning using reward signals from a human preference model without requiring a pre-defined response. Meanwhile, different parameter-efficient fine-tuning strategies have been proposed to reduce the cost of fine-tuning, such as adapters, prompt tuning, etc.

One particular use case of instruction tuning involves adapting LMs to user-oriented applications (e.g., chatbots), where the LMs are fine-tuned on instruction-following examples in a supervised manner to be aligned with human intents. Commonly used datasets for this type of instruction tuning are usually small compared to the pre-training corpus. Such datasets are curated from either crowdsourcing or from a larger model that is already capable of generating instructions-following examples.

One problem with instructing a LM is that current LMs perform poorly at following instructions in prompts, especially prompts that include multiple instructions. For example, an LM may follow some of the instructions, but many times not all of the instructions.

The approaches described in this section are approaches that could be pursued, but not necessarily approaches that have been previously conceived or pursued. Therefore, unless otherwise indicated, it should not be assumed that any of the approaches described in this section qualify as prior art merely by virtue of their inclusion in this section.

### BRIEF DESCRIPTION OF THE DRAWINGS

In the drawings:

FIG. 1 is a block diagram that depicts an example system for improving the instruction following ability of a language model, in an embodiment;

FIG. 2 is a data flow diagram that depicts an example data flow that comprises the elements of the system and inputs and outputs of those elements, in an embodiment;

FIG. 3 is a flow diagram that depicts an example process for improving the following of instructions by a language model, in an embodiment;

FIG. 4 is a block diagram that depicts an example data flow for finetuning a language model, in an embodiment;

FIG. 5 is a block diagram that illustrates a computer system upon which an embodiment of the invention may be implemented;

FIG. 6 is a block diagram of a basic software system that may be employed for controlling the operation of the computer system.

### DETAILED DESCRIPTION

In the following description, for the purposes of explanation, numerous specific details are set forth in order to provide a thorough understanding of the present invention. It will be apparent, however, that the present invention may be practiced without these specific details. In other instances, well-known structures and devices are shown in block diagram form in order to avoid unnecessarily obscuring the present invention.

### General Overview

A system and method for improving the following ability of language models are provided. In one technique, a first language model generates a response based on a prompt that comprises one or more instructions. An instruction identifier (which may be a language model) generates a list of instructions based on the prompt. The list of instructions is presumed to contain all the instructions in the prompt. If the instruction identifier is a language model, then it may be different than the first language model and, thus, may be trained on very different training data. A second language model (which may be the same as the first language model) is asked to verify whether the response indicates that the first language model followed each instruction in the list of instructions. If so, then the response is provided as a response to the prompt. Otherwise, the first language model is asked to follow the one or more instructions that were not followed (“missed instructions”). The first language model may generate the response from scratch or may be provided the response that it generated previously as part of the prompt to follow the missed instructions.

Embodiments improve computer-related technology; specifically, language model technology. Embodiments improve the accuracy and completeness of output generated by language model technology through increasing the likelihood that language models follow instructions in initial prompts.

### System Overview

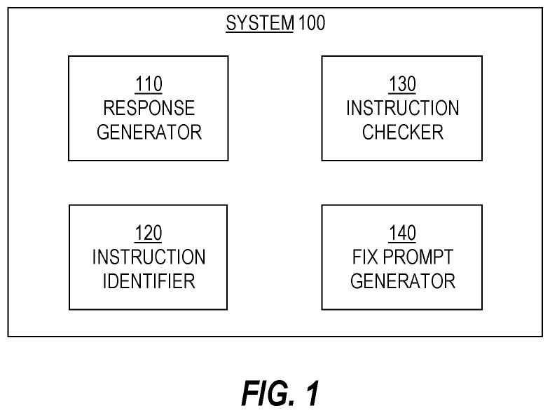

FIG. 1 is a block diagram that depicts an example system 100 for improving the instruction following ability of a language model, in an embodiment. System comprises a response generator 110, an instruction identifier 120, an instruction checker 130, and a fix prompt generator 140. Although system 100 comprises four elements or components, system 100 may include more or fewer elements. Each of elements 110-140 may be implemented in software, hardware, or any combination of software and hardware.

In an embodiment, one or more of elements 110-130 are language models, an example of which are large language models (LLMs).

A language model is a probabilistic model of a natural language. Language models are useful for a variety of tasks, including speech recognition (helping prevent predictions of low-probability (e.g. nonsense) sequences), machine translation, natural language generation (generating more human-like text), optical character recognition, handwriting recognition, grammar induction, and information retrieval. A LLM is a language model notable for its ability to achieve general-purpose language generation and understanding. LLMs acquire these abilities by learning statistical relationships from text documents during a computationally intensive self-supervised and semi-supervised training process. LLMs are artificial neural networks, the largest and most capable of which are built with a transformer-based architecture. Some recent implementations are based on other architectures, such as recurrent neural network variants and Mamba (a state space model).

In a related embodiment, elements 110-130 may be the same language model, may be two language models, or may be three different language models. For example, elements 110 and 130 may be the same language model and may be a general LLM that is trained to perform multiple tasks, such as summarizing a document, generating text (e.g., drafting reports or essays, answering simple questions), etc.; whereas instruction identifier 120 may be specifically trained to only identify instructions in prompts. One or more of elements 110-130 may comprise one or more non-language model components. For example, instruction identifier 120 may implement hard-coded rules and comprise a machine-learned classifier.

Fix prompt generator 140 generates prompts that prompt response generator 110 to fix a response that response generator 110 generated and that was determined (by instruction checker 130) to not reflect the following of one or more instructions in the original prompt. For example, an identified instruction may be that a response is to be less than five hundred words, but the response is greater than five hundred words. Therefore, a fix prompt that fix prompt generator 140 generates instructs response generator 110 to follow that instruction.

### Inference

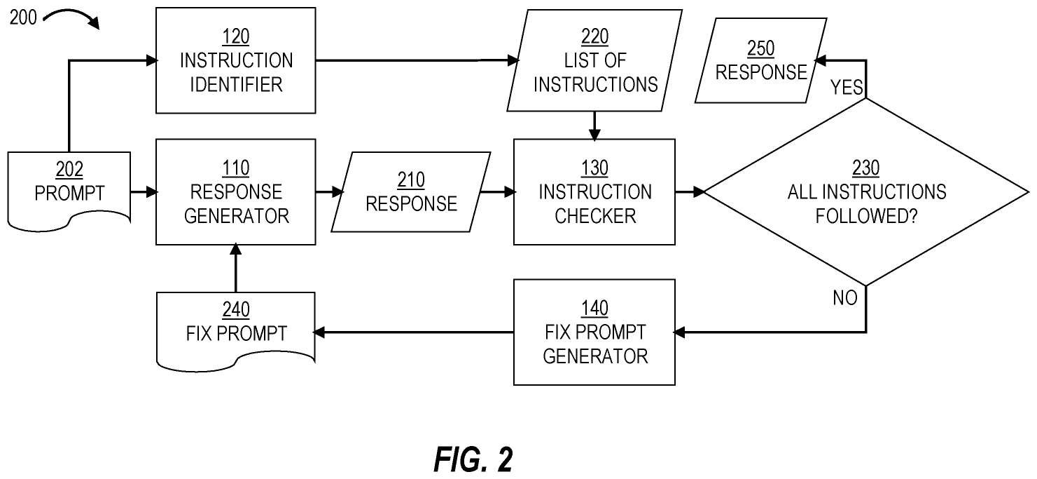

FIG. 2 is a data flow diagram that depicts an example data flow 200 that comprises the elements of system 100 and inputs and outputs of those elements, in an embodiment. Data flow 200 includes a prompt 202, which is text that comprises one or more instructions. Prompt 202 may be composed by a user operating a computing device, such as a laptop computer, a smartphone, a tablet computer, or a desktop computer that is external to system 100 and may be communicatively coupled to system 100 over one or more computer networks, such as a local area network (LAN), a wide area network (WAN), or the Internet. For example, a user may enter text into a keyboard, whether physical or graphical. As another example, a user may speak and a microphone detects the spoken speech and converts the speech into digital audio. A speech-to-text processor accepts the digital audio as input and generates text, which becomes prompt 202. Alternatively, response generator 110 accepts digital audio and performs speech-to-text conversion before processing the resulting text to produce output that is based on the prompt.

Instructions in a prompt may vary greatly, depending on the language in which the prompt is composed. For example, in English, there may be many ways to ask a language model to perform a particular task. An example of a prompt with multiple instructions is “Write a 200 word poem in the style of Dr. Seuss about fruits from Africa.” In this example, multiple instructions are found in the same sentence. Instructions include writing a poem, that the poem have 200 words, that the poem is in the style of Dr. Seuss, that the poem is about fruits, and the fruits are from Africa. If output from a language model based on this prompt is a poem written about fruits in the style of Dr. Seuss, but is not about African fruits, then the language model did not follow the instruction about the poem being about African fruits.

Response generator 110 generates a response 210 based on prompt 202. Response 210 may be text data, audio data, or video data.

### Inference: Instruction Identifier

Prompt 202 is also sent to instruction identifier 120, which may be trained based on associations of prompts and their corresponding instructions. Instruction identifier 120 may be trained on the specific task of generating a list of instructions 220 based on a prompt. Instruction identifier 120 may be trained on positive samples only, or based on positive and negative samples. In a related embodiment, instruction identifier 120 may be the same model as response generator 110.

Alternatively, instruction identifier 120 comprises one or more rule-based components that identifies each sentence in prompt 202 as a separate instruction. A sentence may be delimited based on a period, a semi-colon, a carriage return, etc. Prompt 202 may include multiple sentences, some delimited by different characters.

Alternatively, instruction identifier 120 may be comprised of multiple components, such as one or more rule-based components and a classification component. For example, one rule-based component may break prompt 202 into individuals sentences and another rule-based component may break up (or separate) individual sentences into individual phrases, if applicable. The classification component (or model) classifies whether an input sentence/phrase is an instruction. The classification model is an NLP classification model that may be a Bidirectional Encoder Representations from Transformers (BERT)-based model or a tree-based classification model. Only sentences/phrases that the classification model classifies as an instruction are added to list of instructions 220 for this prompt 202.

In either embodiment, list of instructions 220 that instruction identifier 120 outputs may be in a specific format that is easier for response generator 110 to process and, therefore, more likely to follow.

### Inference: Instruction Checker

Instruction checker 130 accepts (1) response 210 and (2) list of instructions 220 (from instruction identifier 120). Instruction checker 130 performs a check for each instruction in list of instructions 220, which may comprise multiple instructions. Instruction checker 130 (or another component of system 100) reformulates each instruction in list of instructions 220 as a question and includes the question in a new prompt. For example, if a missing instruction is “write a poem that is less than five hundred words,” then a question that may be formulated based on this missing instruction may be “Is the poem less than five hundred words?” Such a reformulator may be another model that is machine-learned based on positive samples of sentences/phrases with their corresponding properly formulated questions.

Instruction checker 130 may be the same model as response generator 110 (and, thus, prompted differently than response generator 110). Alternatively, instruction checker 130 may be a different language model that is trained based on multiple samples, each sample including an output, an instruction, and (in the case of negative samples) an indication whether a language model that generated the output followed the instruction. If the training data on which instruction checker 130 is trained includes only positive samples, then the samples would not need a positive indication.

An accuracy measure of instruction checker 130 may take into account both false positives and false negatives, as determined based on a validation data set and/or a data set derived from data output from production. A score threshold for instruction checker 130 (which threshold is the dividing line between determining whether an instruction has been followed or not) may be selected such that there are no false negatives, ensuring that all missing instructions are found, but which would result in generating unmerited fix prompts. This scenario would be helpful in contexts or use cases where each instruction in a prompt must be followed, such as in a medical case. If it is not critical that each instruction is followed in every prompt, then the score threshold may be selected such that false positives are allowed. If the rate of false positives is above a certain threshold and/or the rate of false negatives is above a certain threshold, then this may trigger a retraining of instruction checker 130.

In a related embodiment, instruction checker 130 accepts, as input, response 210 and a single instruction from list of instructions 220. Thus, each invocation of instruction checker 130 involves a single instruction from list of instructions 220. Therefore, in this embodiment, if instruction identifier 120 extracted four instructions from prompt 202, then instruction checker 130 may be invoked four times, one for each of the four instructions. Also, each invocation would include response 210.

In a related embodiment, instruction checker 130 accepts, as input, response 210 and multiple instructions from list of instructions 220. This may be useful in scenarios where it is determined that instruction checker 130 performs well for multiple instructions, but not multiple instructions that exceed a threshold number. For example, it is determined that instruction checker 130 performs accurately when asking one or two questions (each question corresponding to a different instruction) but does not perform accurately when asking three or more questions. Thus, if list of instructions 220 includes three or more instructions, then instruction checker 130 accepts two instructions at a time until there are no more instructions to consider in list of instructions 220. The threshold number may be determined using one or more experiments involving ground truth data. If output from instruction checker 130 is accurate (according to corresponding ground truth data) a certain percentage that is greater than a first threshold percentage (e.g., 90%) for single instructions, then instruction checker 130 is tested again with two instructions. If output from instruction checker 130 is consistent with corresponding ground truth data a certain percentage that is greater than a second threshold percentage (e.g., over 80%) for two instructions, then instruction checker 130 is tested again with three instructions, but possibly with a different (lower) threshold percentage.

Because there are cost savings in invoking instruction checker 130 fewer times per initial prompt (in terms of time and computing resources), accepting a lower measure of accuracy for a greater number of instructions per invocation may be warranted. If it is determined that accuracy of instruction checker 130 falls below a certain threshold (e.g., that corresponds to the current number of instructions per invocation), then instruction checker 130 may be retrained and/or the number of instructions per invocation is decreased. After the number of instructions per invocation reaches one, then the only recourse (for increasing accuracy of instruction checker 130) is to retrain instruction checker 130, either incrementally on new data or from scratch with an entirely new data set.

An instruction check 230 determines whether response generator 110 followed all instructions in list of instructions 220. Instruction check 230 may be performed by instruction checker 120 or may be a separate component of system 100. Thus, instruction check 230 may be implemented in software, hardware, or a combination of software and hardware. Instruction check 230 accepts output from instruction checker 130. For each instruction that instruction checker 130 determined was not followed (referred to as a “missing instruction”), instruction checker 130 outputs one or more values that indicate that negative determination, such as a ‘0’ or a ‘no.’ If it is determined that response generator 110 followed all instructions from prompt 202, then response 210 becomes response 250. Otherwise, fix prompt generator 240 is invoked.

### Inference: Fix Prompt Generator

Fix prompt generator 140 is provided (e.g., by instruction checker 130 of instruction check 230) the one or more missing instructions, prompt 202, and/or response 210. Based on this input, fix prompt generator 140 generates a fix prompt 240, which asks response generator 110 to follow the one or more missing instructions. Fix prompt 240 may include response 210 and/or the original prompt, i.e., prompt 202. The one or more missing instructions in fix prompt 240 may be more explicit than the instructions in original prompt 202. Fix prompt 240 may also specify the one or more missing instructions as instructions for response generator 110 to follow. The one or more missing instructions may be instructions as formatted in list of instructions 220 or may be formatted differently.

If there are multiple missing instructions, then fix prompt 240 may include (in addition to the original output from response generator 110) all missing instructions for response generator 110 to follow. (In many cases, the number of missing instructions is fewer than the original number of instructions in list of instructions 220 and, therefore, response generator 110 is more likely to follow those missing instructions.) Alternatively, if there are multiple missing instructions, then fix prompt 240 may include (in addition to the original output from response generator 110) a strict subset of the missing instructions. Later, if it is determined that an updated response (from response generator 110) based on fix prompt 240 follows the strict subset of missing instructions, then response generator 110 may be invoked again with another strict subset of the missing instructions in another fix prompt. The other fix prompt may include the updated response.

### Example Process

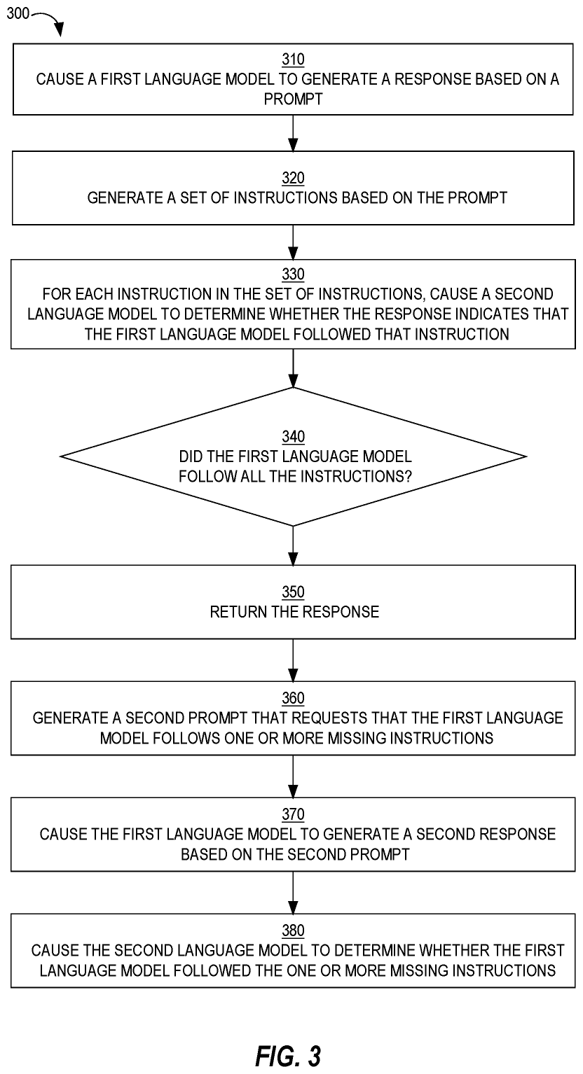

FIG. 3 is a flow diagram that depicts an example process 300 for improving the following of instructions by a language model, in an embodiment. Process 300 is performed by elements of system 100.

At block 310, a first language model generates a response based on a prompt. The prompt may be composed by a user in user input (e.g., text, audio, video) or may be a pre-defined prompt that is selected either manually or automatically based on other user input. Block 310 may be performed by response generator 110. Block 310 may involve a system process invoking the first language model, passing the prompt (that the system process receives from a user's computing device) as input to the call or invocation.

At block 320, a set of instructions is generated based on the prompt. Block 320 may be performed by instruction identifier 120. Block 320 may involve a system process (e.g., the same system process that invokes the first language model) invoking a module or set of code that, when executed, processes the prompt, identifying one or more instructions in the prompt. Block 320 may involve the application of one or more rules that parse or divide the prompt into sentences and/or phrases. Block 320 may also involve invoking a classification model to classify whether each parsed sentence and/or phrase is an instruction.

At block 330, for each instruction in the set of instructions, a second language model determines whether the response indicates that the first language model followed that instruction. The second language model may be the same as, or different than, the first language model. Block 330 may be performed by instruction checker 130. Block 330 may involve automatically generating a check prompt that includes both the response and the instruction and invoking (e.g., by a/the system process) the second language model, passing the check prompt as input to the second language model. Example language in each check prompt is “Verify whether the following response satisfies this instruction [instruction]; [response].” Thus, if there are five instructions in the set of instructions, then five check prompts are generated. Alternatively, a check prompt includes multiple instructions from the set of instructions, whether all the instructions or a strict subset.

At block 340, it is determined whether the first language model followed all the instructions in the set of instructions. Block 340 may be performed by instruction check 230. Block 340 may involve analyzing the output of the second language model based on each check prompt. Thus, block 340 may involve multiple individual checks, one for each instruction in the set of instructions. Block 340 may involve a system process invoking instruction check 230 or another module that performs the check.

If it is determined that the first language model followed all the instructions in the set of instructions, then process 300 proceeds to block 350 where the response is returned as output. Block 350 may involve causing the response to be presented on the same user interface through which the prompt was received. Thus, block 350 may involve transmitting the response over one or more computing networks.

If block 340 resulted in a negative determination, then process 300 proceeds to block 360. A negative determination indicates that there is at least one missing instruction. A negative determination means that the first language model either did not follow any of the instructions in the set of instructions or may have followed at least one of the instructions in the set.

At block 360, a second prompt is generated that requests that the first language model follows one or more missing instructions. The second prompt includes the one or more missing instructions (which may be less than all the instructions) and may include the original prompt and/or the response that was generated based on the original prompt. Block 360 may be performed by fix prompt generator 140.

At block 370, the first language model generates a second response based on the second prompt. Block 370 may involve a system process (e.g., the same system process) invoking the first language model, passing the second prompt as input to the call/invocation.

At block 380, the second language model determines whether the response indicates that the first language model followed the one or more missing instructions that were included in the second prompt. Block 380 is similar to block 330. One or more invocations of block 380 may involve the second language model making this determination for each instruction in the set of instructions or just for the missing instruction(s).

### Finetuning

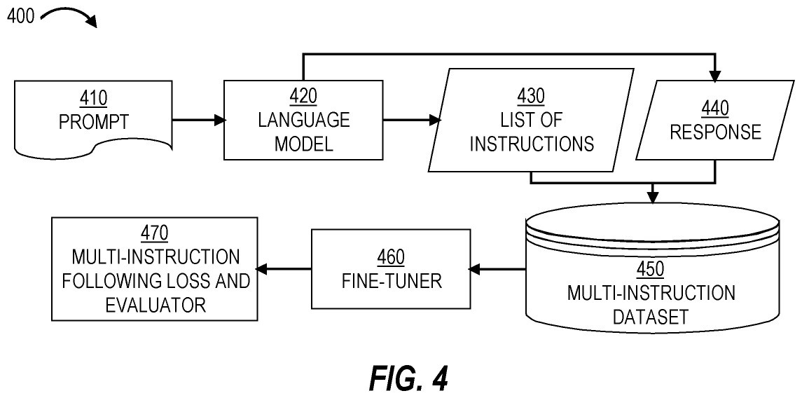

FIG. 4 is a block diagram that depicts an example data flow 400 for finetuning a language model, in an embodiment. Data flow 400 includes a prompt 410, a language model 420, a list of instructions 430, a response 440, a multi-instruction dataset 450, a fine-tuner 460, and a multi-instruction following loss and evaluator 470. Prompt 410 may correspond to an instance of prompt 202 in FIG. 1. Language model 420 may correspond to response generator 110. List of instructions 430 may correspond to an instance of list of instructions 220. Response 440 may correspond to an instance of response 250. Thus, prompt 410 was previously used to generate list of instructions 430 and response 440. In other words, data from the inference stage, as depicted in FIG. 1, is used to finetune response generator 110. “Finetuning a language model” is the same process as training a language model, except finetuning is training an already-trained language model.

Multi-instruction dataset 450 comprises multiple training instances. Each training instance comprises an instance of prompt 410, an instance of list of instructions 430 that was generated based on that instance of prompt 410, and an instance of response 440 that was generated based on that instance of prompt 410 and, optionally, one or more of the instructions in list of instructions 430. For each training instance, it was previously verified (through instruction check 230) that the instance of response 440 indicates that response generator 110 followed the corresponding list of instructions.

One training instance in multi-instruction dataset 450 may have been generated based on a single invocation of instruction check 230, which means response generator 110 followed each instruction in a corresponding prompt. Another training instance in multi-instruction dataset 450 may have been generated based on multiple invocations of instruction check 230, which means that response generator 110 did not follow one or more instructions in a corresponding prompt and one or more fix prompts 240 needed to be generated and issued to ensure that response generator 110 followed all instructions associated with the corresponding original prompt.

Fine-tuner 460 and multi-instruction following loss and evaluator 470 finetune or train response generator 110 based on training instances in multi-instruction dataset 450. The response portion of a training instance constitutes the ground truth in the finetuning/training process. During the finetuning/training process, response generator 110 generates output based on a prompt and/or list of instructions indicated in a training instance. For each word that response generator 110 generates, that word is compared to the next word in the response of the training instance. If the generated word does not match the ground truth, then multi-instruction following loss and evaluator 470 calculates an error based on the specific criteria (multi-instruction following loss) and fine-tuner 460 backpropagates, using gradient descent, the error through a neural network of response generator 110, which backpropagation updates weights of neurons and/or edges in the neural network of response generator 110. Thus, fine-tuner 460 and multi-instruction following loss and evaluator 470 work together to carry-out the error backpropagation. Such backpropagation increases the likelihood that response generator 110 will generate the correct word next time.

Instead of backpropagating for each token/word, batch backpropagating may be implemented, which involves accumulating the losses and the accumulated losses are backpropagated in a single batch.

### Hardware Overview

According to one embodiment, the techniques described herein are implemented by one or more special-purpose computing devices. The special-purpose computing devices may be hard-wired to perform the techniques, or may include digital electronic devices such as one or more application-specific integrated circuits (ASICs) or field programmable gate arrays (FPGAs) that are persistently programmed to perform the techniques, or may include one or more general purpose hardware processors programmed to perform the techniques pursuant to program instructions in firmware, memory, other storage, or a combination. Such special-purpose computing devices may also combine custom hard-wired logic, ASICs, or FPGAs with custom programming to accomplish the techniques. The special-purpose computing devices may be desktop computer systems, portable computer systems, handheld devices, networking devices or any other device that incorporates hard-wired and/or program logic to implement the techniques.

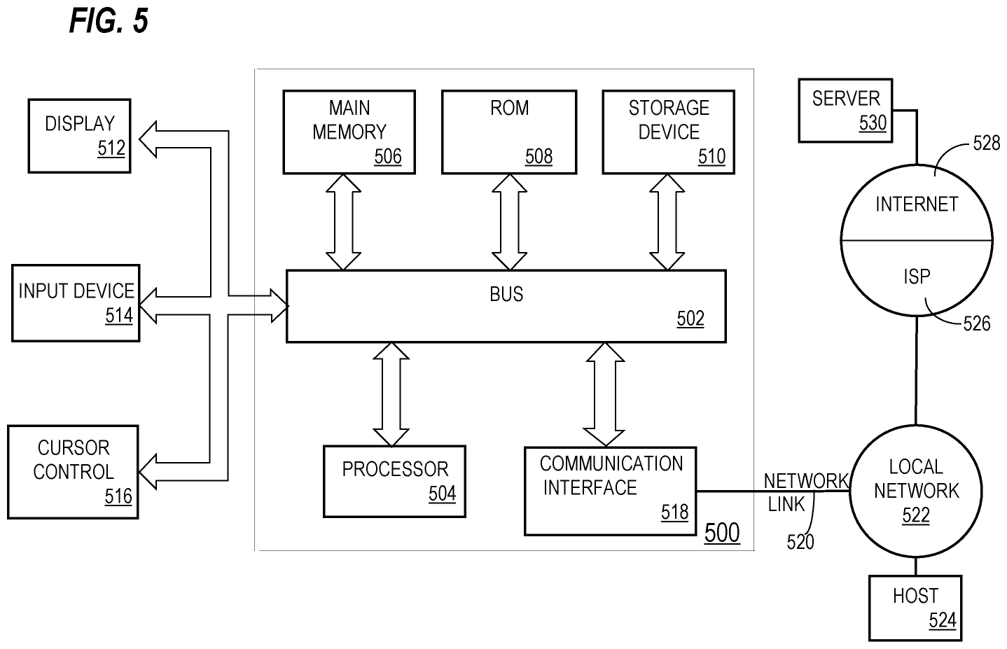

For example, FIG. 5 is a block diagram that illustrates a computer system 500 upon which an embodiment of the invention may be implemented. Computer system 500 includes a bus 502 or other communication mechanism for communicating information, and a hardware processor 504 coupled with bus 502 for processing information. Hardware processor 504 may be, for example, a general purpose microprocessor.

Computer system 500 also includes a main memory 506, such as a random access memory (RAM) or other dynamic storage device, coupled to bus 502 for storing information and instructions to be executed by processor 504. Main memory 506 also may be used for storing temporary variables or other intermediate information during execution of instructions to be executed by processor 504. Such instructions, when stored in non-transitory storage media accessible to processor 504, render computer system 500 into a special-purpose machine that is customized to perform the operations specified in the instructions.

Computer system 500 further includes a read only memory (ROM) 508 or other static storage device coupled to bus 502 for storing static information and instructions for processor 504. A storage device 510, such as a magnetic disk, optical disk, or solid-state drive is provided and coupled to bus 502 for storing information and instructions.

Computer system 500 may be coupled via bus 502 to a display 512, such as a cathode ray tube (CRT), for displaying information to a computer user. An input device 514, including alphanumeric and other keys, is coupled to bus 502 for communicating information and command selections to processor 504. Another type of user input device is cursor control 516, such as a mouse, a trackball, or cursor direction keys for communicating direction information and command selections to processor 504 and for controlling cursor movement on display 512. This input device typically has two degrees of freedom in two axes, a first axis (e.g., x) and a second axis (e.g., y), that allows the device to specify positions in a plane.

Computer system 500 may implement the techniques described herein using customized hard-wired logic, one or more ASICs or FPGAs, firmware and/or program logic which in combination with the computer system causes or programs computer system 500 to be a special-purpose machine. According to one embodiment, the techniques herein are performed by computer system 500 in response to processor 504 executing one or more sequences of one or more instructions contained in main memory 506. Such instructions may be read into main memory 506 from another storage medium, such as storage device 510. Execution of the sequences of instructions contained in main memory 506 causes processor 504 to perform the process steps described herein. In alternative embodiments, hard-wired circuitry may be used in place of or in combination with software instructions.

The term “storage media” as used herein refers to any non-transitory media that store data and/or instructions that cause a machine to operate in a specific fashion. Such storage media may comprise non-volatile media and/or volatile media. Non-volatile media includes, for example, optical disks, magnetic disks, or solid-state drives, such as storage device 510. Volatile media includes dynamic memory, such as main memory 506. Common forms of storage media include, for example, a floppy disk, a flexible disk, hard disk, solid-state drive, magnetic tape, or any other magnetic data storage medium, a CD-ROM, any other optical data storage medium, any physical medium with patterns of holes, a RAM, a PROM, and EPROM, a FLASH-EPROM, NVRAM, any other memory chip or cartridge.

Storage media is distinct from but may be used in conjunction with transmission media. Transmission media participates in transferring information between storage media. For example, transmission media includes coaxial cables, copper wire and fiber optics, including the wires that comprise bus 502. Transmission media can also take the form of acoustic or light waves, such as those generated during radio-wave and infra-red data communications.

Various forms of media may be involved in carrying one or more sequences of one or more instructions to processor 504 for execution. For example, the instructions may initially be carried on a magnetic disk or solid-state drive of a remote computer. The remote computer can load the instructions into its dynamic memory and send the instructions over a telephone line using a modem. A modem local to computer system 500 can receive the data on the telephone line and use an infra-red transmitter to convert the data to an infra-red signal. An infra-red detector can receive the data carried in the infra-red signal and appropriate circuitry can place the data on bus 502. Bus 502 carries the data to main memory 506, from which processor 504 retrieves and executes the instructions. The instructions received by main memory 506 may optionally be stored on storage device 510 either before or after execution by processor 504.

Computer system 500 also includes a communication interface 518 coupled to bus 502. Communication interface 518 provides a two-way data communication coupling to a network link 520 that is connected to a local network 522. For example, communication interface 518 may be an integrated services digital network (ISDN) card, cable modem, satellite modem, or a modem to provide a data communication connection to a corresponding type of telephone line. As another example, communication interface 518 may be a local area network (LAN) card to provide a data communication connection to a compatible LAN. Wireless links may also be implemented. In any such implementation, communication interface 518 sends and receives electrical, electromagnetic, or optical signals that carry digital data streams representing various types of information.

Network link 520 typically provides data communication through one or more networks to other data devices. For example, network link 520 may provide a connection through local network 522 to a host computer 524 or to data equipment operated by an Internet Service Provider (ISP) 526. ISP 526 in turn provides data communication services through the worldwide packet data communication network now commonly referred to as the “Internet” 528. Local network 522 and Internet 528 both use electrical, electromagnetic, or optical signals that carry digital data streams. The signals through the various networks and the signals on network link 520 and through communication interface 518, which carry the digital data to and from computer system 500, are example forms of transmission media.

Computer system 500 can send messages and receive data, including program code, through the network(s), network link 520 and communication interface 518. In the Internet example, a server 530 might transmit a requested code for an application program through Internet 528, ISP 526, local network 522 and communication interface 518.

The received code may be executed by processor 504 as it is received, and/or stored in storage device 510, or other non-volatile storage for later execution.

### Software Overview

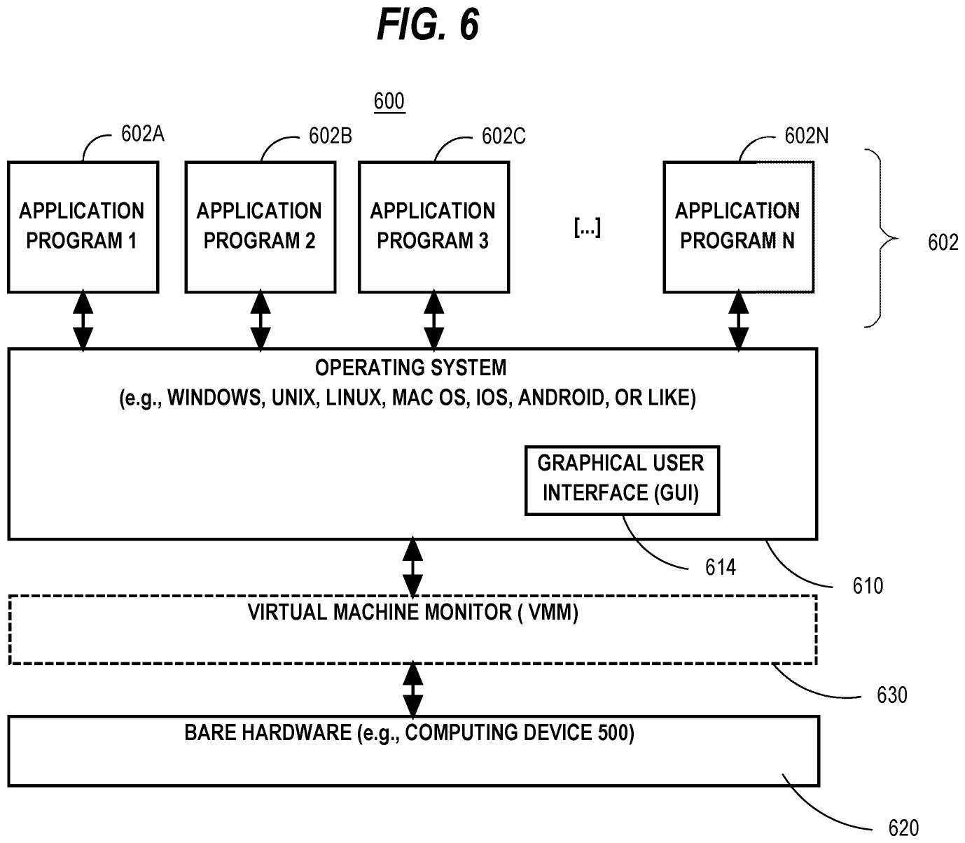

FIG. 6 is a block diagram of a basic software system 600 that may be employed for controlling the operation of computer system 500. Software system 600 and its components, including their connections, relationships, and functions, is meant to be exemplary only, and not meant to limit implementations of the example embodiment(s). Other software systems suitable for implementing the example embodiment(s) may have different components, including components with different connections, relationships, and functions.

Software system 600 is provided for directing the operation of computer system 500. Software system 600, which may be stored in system memory (RAM) 506 and on fixed storage (e.g., hard disk or flash memory) 510, includes a kernel or operating system (OS) 610.

The OS 610 manages low-level aspects of computer operation, including managing execution of processes, memory allocation, file input and output (I/O), and device I/O. One or more application programs, represented as 602A, 602B, 602C . . . 602N, may be “loaded” (e.g., transferred from fixed storage 510 into memory 506) for execution by the system 600. The applications or other software intended for use on computer system 500 may also be stored as a set of downloadable computer-executable instructions, for example, for downloading and installation from an Internet location (e.g., a Web server, an app store, or other online service).

Software system 600 includes a graphical user interface (GUI) 615, for receiving user commands and data in a graphical (e.g., “point-and-click” or “touch gesture”) fashion. These inputs, in turn, may be acted upon by the system 600 in accordance with instructions from operating system 610 and/or application(s) 602. The GUI 615 also serves to display the results of operation from the OS 610 and application(s) 602, whereupon the user may supply additional inputs or terminate the session (e.g., log off).

OS 610 can execute directly on the bare hardware 620 (e.g., processor(s) 504) of computer system 500. Alternatively, a hypervisor or virtual machine monitor (VMM) 630 may be interposed between the bare hardware 620 and the OS 610. In this configuration, VMM 630 acts as a software “cushion” or virtualization layer between the OS 610 and the bare hardware 620 of the computer system 500.

VMM 630 instantiates and runs one or more virtual machine instances (“guest machines”). Each guest machine comprises a “guest” operating system, such as OS 610, and one or more applications, such as application(s) 602, designed to execute on the guest operating system. The VMM 630 presents the guest operating systems with a virtual operating platform and manages the execution of the guest operating systems.

In some instances, the VMM 630 may allow a guest operating system to run as if it is running on the bare hardware 620 of computer system 500 directly. In these instances, the same version of the guest operating system configured to execute on the bare hardware 620 directly may also execute on VMM 630 without modification or reconfiguration. In other words, VMM 630 may provide full hardware and CPU virtualization to a guest operating system in some instances.

In other instances, a guest operating system may be specially designed or configured to execute on VMM 630 for efficiency. In these instances, the guest operating system is “aware” that it executes on a virtual machine monitor. In other words, VMM 630 may provide para-virtualization to a guest operating system in some instances.

A computer system process comprises an allotment of hardware processor time, and an allotment of memory (physical and/or virtual), the allotment of memory being for storing instructions executed by the hardware processor, for storing data generated by the hardware processor executing the instructions, and/or for storing the hardware processor state (e.g. content of registers) between allotments of the hardware processor time when the computer system process is not running. Computer system processes run under the control of an operating system, and may run under the control of other programs being executed on the computer system.

The above-described basic computer hardware and software is presented for purposes of illustrating the basic underlying computer components that may be employed for implementing the example embodiment(s). The example embodiment(s), however, are not necessarily limited to any particular computing environment or computing device configuration. Instead, the example embodiment(s) may be implemented in any type of system architecture or processing environment that one skilled in the art, in light of this disclosure, would understand as capable of supporting the features and functions of the example embodiment(s) presented herein.

### Cloud Computing

The term “cloud computing” is generally used herein to describe a computing model which enables on-demand access to a shared pool of computing resources, such as computer networks, servers, software applications, and services, and which allows for rapid provisioning and release of resources with minimal management effort or service provider interaction.

A cloud computing environment (sometimes referred to as a cloud environment, or a cloud) can be implemented in a variety of different ways to best suit different requirements. For example, in a public cloud environment, the underlying computing infrastructure is owned by an organization that makes its cloud services available to other organizations or to the general public. In contrast, a private cloud environment is generally intended solely for use by, or within, a single organization. A community cloud is intended to be shared by several organizations within a community; while a hybrid cloud comprises two or more types of cloud (e.g., private, community, or public) that are bound together by data and application portability.

Generally, a cloud computing model enables some of those responsibilities which previously may have been provided by an organization's own information technology department, to instead be delivered as service layers within a cloud environment, for use by consumers (either within or external to the organization, according to the cloud's public/private nature). Depending on the particular implementation, the precise definition of components or features provided by or within each cloud service layer can vary, but common examples include: Software as a Service (SaaS), in which consumers use software applications that are running upon a cloud infrastructure, while a SaaS provider manages or controls the underlying cloud infrastructure and applications. Platform as a Service (PaaS), in which consumers can use software programming languages and development tools supported by a PaaS provider to develop, deploy, and otherwise control their own applications, while the PaaS provider manages or controls other aspects of the cloud environment (i.e., everything below the run-time execution environment). Infrastructure as a Service (IaaS), in which consumers can deploy and run arbitrary software applications, and/or provision processing, storage, networks, and other fundamental computing resources, while an IaaS provider manages or controls the underlying physical cloud infrastructure (i.e., everything below the operating system layer). Database as a Service (DBaaS) in which consumers use a database server or Database Management System that is running upon a cloud infrastructure, while a DbaaS provider manages or controls the underlying cloud infrastructure, applications, and servers, including one or more database servers.

In the foregoing specification, embodiments of the invention have been described with reference to numerous specific details that may vary from implementation to implementation. The specification and drawings are, accordingly, to be regarded in an illustrative rather than a restrictive sense. The sole and exclusive indicator of the scope of the invention, and what is intended by the applicants to be the scope of the invention, is the literal and equivalent scope of the set of claims that issue from this application, in the specific form in which such claims issue, including any subsequent correction.

What is claimed is:

1. A method comprising:
causing a first language model to generate a response based on a prompt;
identifying a set of instructions in the prompt;
for each instruction in the set of instructions, causing a second language model to determine whether the response indicates that the first language model followed said each instruction;
in response to determining that the response indicates that the first language model did not follow a particular instruction in the set of instructions:
generating a second prompt that prompts the first language model to follow the particular instruction;
causing the first language model to generate a second response based on the second prompt;
wherein the method is performed by one or more computing devices.

2. The method of claim 1, further comprising:
in response to determining that the second response indicates that the first language model followed each instruction in the set of instructions, providing the second response to the prompt.

3. The method of claim 2, further comprising:
storing the second prompt, the second response, and the set of instructions as a training instance in a training dataset;
finetuning the first language model based on the training dataset.

4. The method of claim 1, wherein identifying the set of instructions comprises:
identifying a plurality of sentences in the prompt;
for each sentence of one or more sentences in the plurality of sentences, identifying a plurality of phrases in said each sentence;
for each sentence or phrase in the plurality of sentences or the plurality of phrases, determine whether said each sentence or phrase is an instruction.

5. The method of claim 1, wherein the second prompt includes the response.

6. The method of claim 1, wherein the second prompt includes the prompt.

7. The method of claim 1, further comprising:
causing the second language model to determine whether the second response indicates that the first language model followed the particular instruction.

8. The method of claim 1, wherein the second prompt prompts the first language model to follow each instruction in the set of instructions.

9. The method of claim 1, wherein the first language model and the second language model are the same language model.

10. A method comprising:
for each prompt of a plurality of prompts:
causing a first language model to generate a response based on said each prompt;
identifying a plurality of instructions based on said each prompt;
causing a second language model to generate, based on the plurality of instructions, one or more outputs that indicate that the first language model followed each instruction in the plurality of instructions;
storing the prompt, the response, and the plurality of instructions in a training instance;
adding the training instance to training data;
finetuning the first language model based on the training data;
wherein the method is performed by one or more computing devices.

11. The method of claim 10, wherein finetuning the first language model comprises:
identifying, in the training data, a first training instance that comprises a first prompt, a first plurality of instructions, and a first response;
causing the first language model to generate a particular response based on the first prompt in the first training instance;
based on the particular response, determining whether the first language model followed all of the instructions in the first plurality of instructions;
in response to determining that the first language model did not follow all of the instructions in the first plurality of instructions, backpropagating a loss to the first language model.

12. One or more non-transitory storage media storing instructions which, when executed by one or more computing devices, cause:
causing a first language model to generate a response based on a prompt;
identifying a set of instructions in the prompt;
for each instruction in the set of instructions, causing a second language model to determine whether the response indicates that the first language model followed said each instruction.

13. The one or more storage media of claim 12, further comprising:
in response to determining that the response indicates that the first language model followed each instruction in the set of instructions, providing the response to the prompt.

14. The one or more storage media of claim 13, further comprising:
storing the prompt, the response, and the set of instructions as a training instance in a training dataset;
finetuning the first language model based on the training dataset.

15. The one or more storage media of claim 12, wherein identifying the set of instructions comprises:
identifying a plurality of sentences in the prompt;
for each sentence of one or more sentences in the plurality of sentences, identifying a plurality of phrases in said each sentence;
for each sentence or phrase in the plurality of sentences or the plurality of phrases, determine whether said each sentence or phrase is an instruction.

16. The one or more storage media of claim 12, further comprising:
in response to determining that the response indicates that the first language model did not follow a particular instruction in the set of instructions:
generating a second prompt that prompts the first language model to follow the particular instruction;
causing the first language model to generate a second response based on the second prompt.

17. The one or more storage media of claim 16, wherein the second prompt includes the response or the prompt.

18. The one or more storage media of claim 16, further comprising:
causing the second language model to determine whether the second response indicates that the first language model followed the particular instruction.

19. The one or more storage media of claim 16, wherein the second prompt prompts the first language model to follow each instruction in the set of instructions.

20. The one or more storage media of claim 12, wherein the first language model and the second language model are the same language model.
